(19) United States
(12) Patent Application Publication
(10) Pub. No.: US 2026/0053696 A1
(43) Pub. Date: Feb. 26, 2026

(54) MASSAGER WITH SWING STRUCTURE

(71) Applicant: Dongguan Guigong Adult Supplies. Co., Ltd., Dongguan (CN)

(72) Inventor: Liqing NIU, Chenzhou City (CN)

(21) Appl. No.: 18/894,240

(22) Filed: Sep. 24, 2024

(30) Foreign Application Priority Data
Aug. 21, 2024 (CN) 202422035735.X

(51) Int. Cl. A61H 19/00; A61H 23/02

(52) U.S. Cl. CPC A61H 19/30; A61H 19/44; A61H 23/0254; A61H 2201/0192; A61H 2201/1215; A61H 2201/1669; A61H 2201/1676; A61H 2205/087

(57) ABSTRACT

Disclosed is a massager with a swing structure, includes a main body and a swing mechanism, the main body is a shell provided with an inner cavity, a groove position is disposed at the front part of the main body, a strip-shaped cavity is disposed in the groove position, the swing mechanism includes a driving apparatus disposed in the inner cavity and a swing tongue extending into the groove position, the middle part of the swing tongue is pivotally mounted in the inner cavity, and when the swing tongue extends out of the strip-shaped cavity, the end part of the swing tongue extends out of the outer peripheral wall of the main body; and the driving apparatus may drive the swing tongue to swing in a reciprocating mode between a position extending out of the strip-shaped cavity and a position retreating into the strip-shaped cavity through the connecting rod.

### CROSS-REFERENCE TO RELATED APPLICATIONS

This application claims priority benefits to Chinese Patent Application No. 202422035735.X, filed on Aug. 21, 2024, the contents of which is incorporated herein by reference.

### TECHNICAL FIELD

The present application relates to the field of adult products, in particular to a massager with a swing structure.

### BACKGROUND

For existing female adult products, a single simulated penis structure is generally adopted, and a vibration motor or a telescopic mechanism is disposed at the end of the penis so as to realize stimulation for a sensitive position.

However, in practical application, it is found that the single penis structure can only simulate the stimulation of reciprocating stretching and contraction or vibration on a certain sensitive point, and the stimulation is relatively single, so that the use experience is affected.

Of course, there is also a way to stimulate the sensitive point, in which a rotating motor cooperates with a swing shaft to realize swing, but the structure still has the following problems: 1. the reverse vibration force is large, and the main factor is that when a cam works, part of torque is consumed by rotation torque and then converted into reaction force, so that the stimulation is not flexible in force control (namely, the swing mode is not linear enough, and the problem of jerk exists at the maximum outer arc of the cam); and 2. the rotating motor is generally large in diameter, thus limiting the size of the penis, and therefore, a larger hard shell is required to cover it so that the comfort is not affected.

### SUMMARY

A main objective of the present application is to provide a massager with a swing structure, aiming at improving the structure of the existing female adult product, so that while penis simulation is realized, the function of licking or poking may be realized, and then the stimulation to a sensitive point is improved.

In order to realize the purpose, the present application provides a massager with a swing structure, which includes a main body and a swing mechanism.

The main body is a shell provided with a first inner cavity, a groove position is disposed at the front part of the main body, and a strip-shaped cavity is disposed in the groove position.

The swing mechanism includes a driving apparatus and a swing tongue, the driving apparatus is disposed in the first inner cavity, the swing tongue may extend into the strip-shaped cavity, and the middle part of the swing tongue is pivotally mounted in the first inner cavity.

When the swing tongue extends out of the strip-shaped cavity, the front end of the swing tongue extends out of the outer peripheral wall of the main body.

The driving apparatus includes a telescopic device and a connecting rod, the connecting rod is connected with the telescopic device, and two ends of the connecting rod are respectively in pivot connection with the driving end of the telescopic device and the rear end of the swing tongue.

The driving apparatus may drive the swing tongue to swing in a reciprocating mode through the connecting rod so as to extend out of the strip-shaped cavity or extend into the strip-shaped cavity.

In specific use, the main body may extend into a predetermined channel (such as the vagina), when the front part of the main body extends into the channel or stays at a predetermined position of the channel (in such a case, the swing tongue retreats into the strip-shaped cavity), and when the telescopic device drives the swing tongue to swing through the connecting rod, poking for the channel part may be realized, or the action of licking is realized at the position of the opening of the channel, so that multi-dimensional stimulation is realized, of course, in practical use, the main body may also realize the function of reciprocating stretching and contraction through human hands or has the function of reciprocating stretching and contraction intrinsically, therefore, the use experience is further improved, meanwhile, the structure is stable, compared with a cam structure, the reaction force is effectively reduced, the use is more convenient, and in addition, the force is more flexible, which better meets the simulation effect (such as the finger or the tongue).

### BRIEF DESCRIPTION OF THE DRAWINGS

FIG. 1 is a schematic diagram of an exploded view of the present application.

FIG. 2 is a schematic diagram of a sectional view of the present application.

FIG. 3 is a schematic diagram of a three-dimensional view of the present application.

FIG. 4 is a schematic diagram of an exploded view of a telescopic device.

FIG. 5 is a schematic diagram of a sectional view of a telescopic device.

FIG. 6 is a schematic diagram of a three-dimensional view of a telescopic device.

FIG. 7 is a schematic diagram when a connecting rod is provided with two swing tongues.

FIG. 8 is a schematic diagram of cooperation of a connecting rod with two driving arms when a connecting rod is provided with two swing tongues.

### DETAILED DESCRIPTION OF THE EMBODIMENTS

The technical solutions in the embodiments of the present application will be clearly and completely described below in combination with the drawings, and it is apparent that the described embodiments are not all but part of the embodiments of the present application. All other embodiments obtained by those of ordinary skill in the art on the basis of the embodiments in the present application without creative work shall fall within the scope of protection of the present application.

It is to be noted that if the embodiments of the present application contain directional indications (such as up, down, left, right, front, back, top, bottom, inside, outside, vertical, transverse, longitudinal, counterclockwise, clockwise, circumferential, radial, axial . . . ), the directional indications are only used to explain the relative position relationship and motion between the components under a specific attitude (as shown in the attached figures). If the specific attitude changes, the directional indication will change accordingly.

In addition, if there is a description of “first” or “second” in the embodiments of the present application, the description of “first” or “second” is only adopted for description and should not be understood to indicate or imply relative importance or implicitly indicate the number of indicated technical features. Therefore, a feature defined by “first” and “second” may explicitly or implicitly indicate inclusion of at least one such feature. In addition, the technical solutions among the embodiments can be combined with each other, but must be based on implementation of those of ordinary skill in the art. When the combination of technical solution is contradictory or impossible to implement, it shall be considered that such combination of the technical solution does not exist and is not within the scope of protection of the present application.

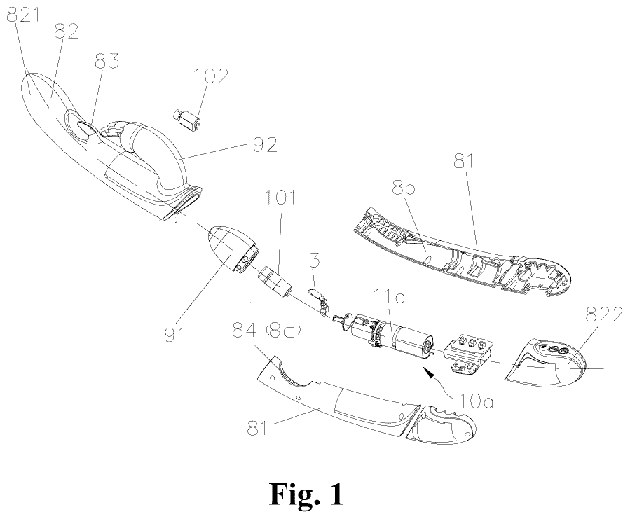

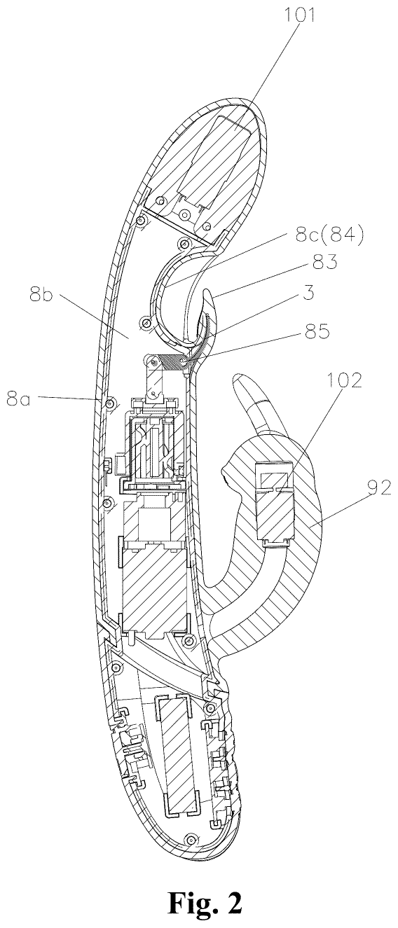

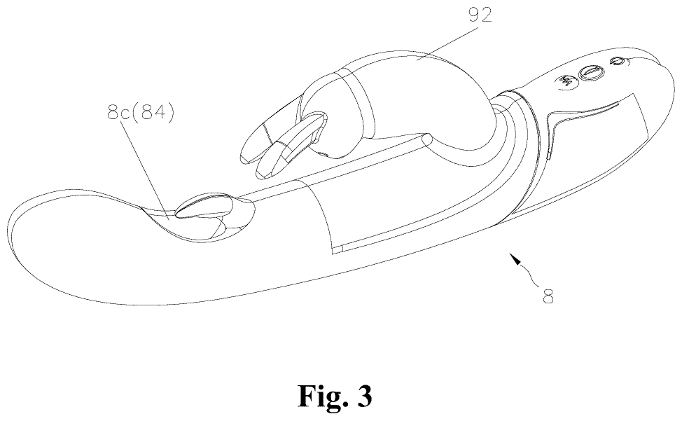

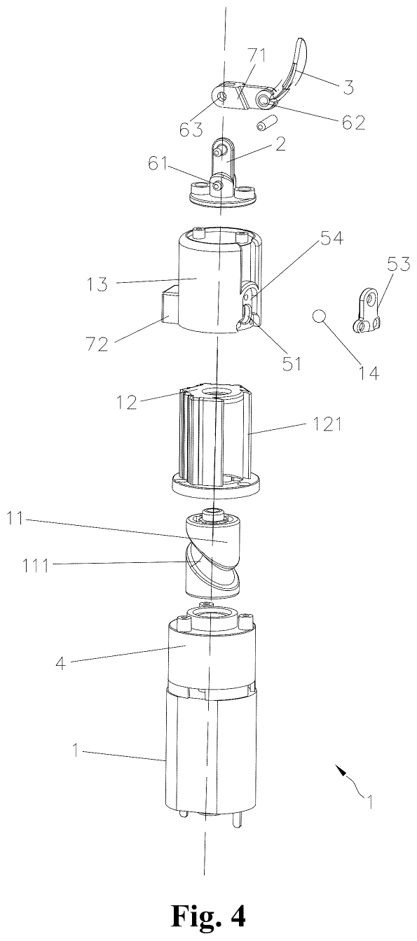

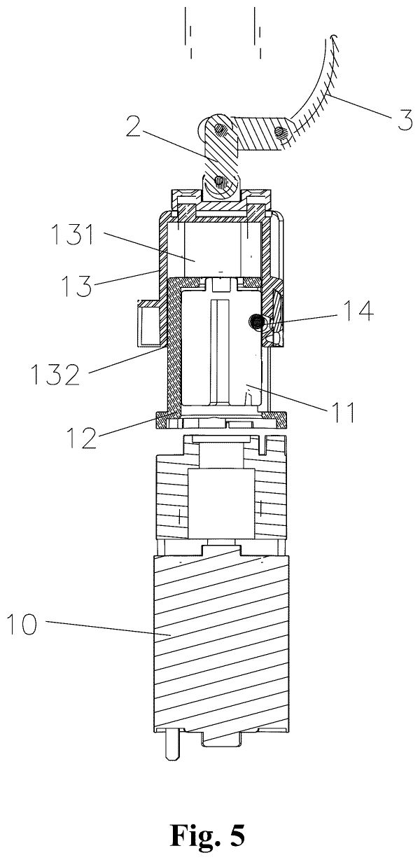

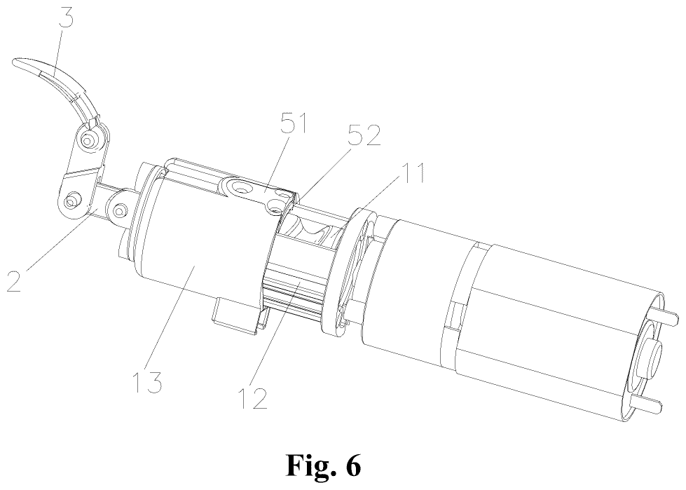

As shown in FIGS. 1-7, a massager with a swing structure includes: a main body 8 and a driving mechanism 10a.

The main body 8 is a shell 8a provided with a first inner cavity 8b, a groove position 8c is disposed at the front part of the main body 8, and a strip-shaped cavity 84 is disposed in the groove position 8c.

The swing mechanism 10a includes a driving apparatus 11a and a swing tongue 3, the driving apparatus 11a is disposed in the first inner cavity 8b, the swing tongue 3 may extend into the groove position 8c and the strip-shaped cavity 84, and the middle part of the swing tongue 3 is pivotally mounted in the first inner cavity 8b.

When the swing tongue 3 extends out of the strip-shaped cavity 84, the front end of the swing tongue 3 extends out of the outer peripheral wall of the main body 8.

The driving apparatus 11a includes a telescopic device 1 and a connecting rod 2, the connecting rod 2 is connected with the telescopic device 1, and two ends of the connecting rod 2 are respectively in pivot connection with the driving end of the telescopic device 1 and the rear end of the swing tongue 3.

The driving apparatus 11a may drive the swing tongue 3 to swing in a reciprocating mode through the connecting rod 2 so as to swing in a reciprocating mode between a position extending out of the strip-shaped cavity 84 and a position retreating into the strip-shaped cavity 84.

In specific use, the main body 8 may extend into a predetermined channel (such as the vagina), when the front part of the main body 8 extends into the channel or stays at a predetermined position of the channel (in such a case, the swing tongue 3 retreats into the strip-shaped cavity 84), and when the telescopic device 1 drives the swing tongue 3 to swing through the connecting rod 2, poking for the channel part may be realized, or the action of licking is realized at the position of an opening of the channel, so that multi-dimensional stimulation is realized, of course, in practical use, the main body 8 may also realize the function of reciprocating stretching and contraction through human hands or has the function of reciprocating stretching and contraction intrinsically, therefore, the use experience is further improved, meanwhile, the structure is stable, compared with a cam structure, the reaction force is effectively reduced, the use is more convenient, and in addition, the force is more flexible, which better meets the simulation effect (such as the finger or the tongue).

Specifically, the groove position 8c is a through groove or a groove disposed in the main body 8 in a penetrating mode.

Specifically, the telescopic device 1 is a telescopic motor or a telescopic cylinder.

Telescopic device 1 is miniaturized, so that reciprocating swing of the front end of the swing tongue 3 is realized, further, the preset working frequency is ensured, and stimulation of preset frequency is formed.

Specifically, the telescopic device 1 includes a rotating motor 10, a guide seat 12 and a sliding seat 13.

The rotating motor 10 is connected with a rotating seat 11, the rotating seat 11 is cylindrical, a guide groove 111 is disposed in the outer peripheral wall of the rotating seat 11, and the highest point and the lowest point of the guide groove 111 are not on the same horizontal plane.

The guide seat 12 is disposed on the outer peripheral wall of the rotating seat 11, a vertical groove 121 is disposed on the guide seat 12, and the vertical groove 121 is disposed along the height direction of the guide seat 12.

The sliding seat 13 is provided with a second inner cavity 131, an opening 132 is formed at the lower end of the second inner cavity 131, the guide seat 12 extends into the second inner cavity 131, and the sliding seat 13 may slide vertically along the height direction of the guide seat 12.

A ball 14 is disposed on the inner wall of the sliding seat 13, the ball 14 is clamped in the guide groove 111 after passing through the vertical groove 121, and when the rotating seat 11 rotates, the sliding seat 13 is driven to vertically move in a reciprocating mode through the ball 14.

By disposing the guide groove 111 in the rotating seat 11 and the vertical groove 121 in the sliding seat 13, the guide groove 111 cooperates with the ball 14, the rotating motor 10 may drive the rotating seat 11 to rotate along the axis, meanwhile, the ball 14 is always in a vertical position, therefore, the ball 14 rises or falls under driving of the guide groove 111, so that the sliding seat 13 is driven to vertically move in a reciprocating mode along the guide seat 12, through the guide groove 111 disposed in closed loop, turning of up and down directions of the sliding seat 13 is realized, and further, the service life of the rotating motor 10 is effectively prolonged.

The key point of the design is to convert a rotation stroke into a vertical stroke and finally convert the vertical stroke into a swing stroke.

Specifically, a gear box 4 is disposed between the rotating motor 10 and the rotating seat 11, so that the rotating torque is improved, and the stability of rotation is ensured.

Specifically, the guide groove 111 is composed of two arc-shaped grooves disposed symmetrically.

Specifically, a first half groove 51 is disposed in the sliding seat 13, the ball may be partially clamped in the first half groove 51, meanwhile, the extending part is clamped in the guide groove 111, so that the ball is partially exposed and partially clamped in the guide groove 111, and the rotating seat 11 is driven to move.

Specifically, the sliding seat 13 is provided with a convex part 52 extending into the vertical groove 121, the convex part 52 may vertically slide along the direction of the vertical groove 121, and through the reasonable design, the stability of vertical sliding of the sliding seat 13 is improved.

Specifically, the convex part 52 is provided with a second half groove 54, and the second half groove 54 is provided with a detachable cover body 53, so that mounting of the ball 14 is facilitated.

Specifically, a first pivoting part 61 is disposed at the top end of the sliding seat 13, and the lower end of the connecting rod 2 is in pivot connection with the first pivoting part 61.

Specifically, a second pivoting part 62 is disposed in the middle of the swing tongue 3, a driving arm 71 extends from the rear part of the swing tongue 3, a third pivoting part 63 is disposed at the position, away from the second pivoting part 62, of the driving arm 71, the third pivoting part 63 is in pivot connection with the upper end of the connecting rod 2, through vertical reciprocating movement of the connecting rod 2, the reciprocating swing of the front end of the swing tongue 3 is realized, further, stimulation to the sensitive point is realized, and the action is relatively linear.

Specifically, the front end of the swing tongue 3 is arc-shaped, through a preset radian, covering of a silica gel layer is facilitated, and meanwhile, the effect of simulating the human tongue is also realized.

Specifically, a position sensor 72 is disposed between the lower end of the sliding seat 13 and the lower end of the guide seat 12, the position sensor 72 is configured to detect whether the front end of the swing tongue 3 extends into the groove position 8c or not, with the arrangement of the position sensor 72, in use, the problem that the main body 8 cannot extend into a predetermined channel, the phenomenon of inverse hooking occurs (namely, when the swing tongue 3 extends out of the groove position 8c, the main body cannot extend into the channel (for example, the vagina)) may be solved.

As an implementation mode of the position sensor 72, the position sensor includes a receiver and an emitter, the receiver and the emitter are respectively disposed on the sliding seat and the guide seat, and when the receiver and the emitter sense each other, it is determined that the swing tongue extends into the groove position.

Specifically, the main body 8 includes a hard shell 81 and a soft shell 82 for covering the hard shell 81, the soft shell 82 is provided with a covering part 83 adaptive to the swing tongue 3, the covering part 83 and the soft shell 82 are integrally formed by injection molding, so that the simulation effect of use is ensured, and meanwhile, the comfort and softness of the swing tongue 3 part are ensured.

Specifically, the hard shell 81 is provided with a groove position, a pivoting hole 85 is disposed at the position of the groove position 8c, the middle of the swing tongue 3 is pivotally mounted to the pivoting hole 85, and the front part of the swing tongue 3 extends into the groove position 8c.

Specifically, a front end shell 91 is disposed at the front end of the hard shell 81, and the front end may be provided with a first vibration motor 101, so that stimulation to the channel may be improved.

Specifically, the soft shell 82 includes a front soft shell 821 and a rear soft shell 822, the rear soft shell 822 is disposed at the rear part of the front soft shell 821, the front soft shell 821 and the rear soft shell are configured to completely cover the hard shell 81, the covering part 83 is disposed on the front soft shell 821, due to the arrangement of the structure, the waterproofness and sealing property of the front end may be ensured, and meanwhile, mounting is facilitated.

Specifically, a support arm 92 integrally extends from the rear part of the front soft shell 821, and a second vibration motor 102 is disposed in the support arm 92, so that the stimulation to the sensitive point is further improved.

Specifically, the swing tongue 3 is gradually reduced backwards from the front end. Of course, specifically, the swing tongue 3 may also be set to be of a strip shape, an arc shape, a round shape or a plurality of strips according to actual requirements.

The swing tongue 3 is disposed obliquely or vertically from the upper section of the driving arm 71, preferably, oblique arrangement is adopted, so that staggered swing is realized.

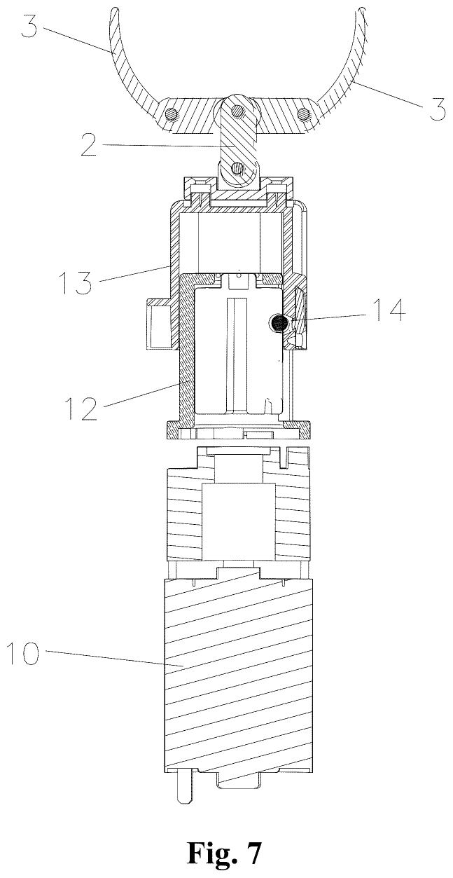

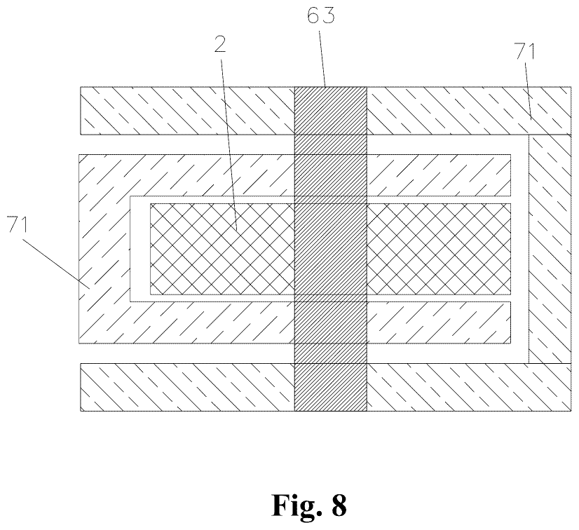

As shown in FIGS. 7 and 8, two swing tongues 3 are disposed at the upper end of the connecting rod 2, the two swing tongues 3 are disposed on two sides of the connecting rod 2 symmetrically, driving arms 71 of the two swing tongues 3 are disposed in a staggered mode, and the two driving arms 71 are pivotally mounted on the same third pivoting part 63. When two sides of the main body 8 are provided with strip-shaped cavities 84 symmetrically disposed, the upper end of the connecting rod 2, through the driving arms 71 disposed in a staggered mode, realizes simultaneous linking of the two swing tongues 3, so that the stimulation effect is effectively improved.

The above description is preferred embodiments of the present application, and is not intended to limit the scope of the present application, under the invention concept of the present application, the equivalent structural transformation performed by using the contents of the specification and the drawings of the present application, or directly or indirectly applied to other related technical fields, are included in the scope of the present application.

What is claimed is:

1. A massager with a swing structure, comprising:
a main body, which is a shell provided with a first inner cavity, a groove position is disposed at the front part of the main body, and a strip-shaped cavity is disposed in the groove position;
a swing mechanism, which comprises a driving apparatus and a swing tongue, the driving apparatus is disposed in the first inner cavity, the swing tongue may extend into the strip-shaped cavity, the middle part of the swing tongue is pivotally mounted in the first inner cavity, when the swing tongue extends out of the strip-shaped cavity, the front end of the swing tongue extends out of the outer peripheral wall of the main body;
the driving apparatus comprises a telescopic device and a connecting rod, the connecting rod is connected with the telescopic device, and two ends of the connecting rod are respectively in pivot connection with the driving end of the telescopic device and the rear end of the swing tongue;
the driving apparatus may drive the swing tongue to swing in a reciprocating mode through the connecting rod so as to extend out of the strip-shaped cavity or extend into the strip-shaped cavity.

2. The massager with a swing structure as claimed in claim 1, wherein the groove position is a through groove or a groove disposed in the main body in a penetrating mode or two grooves disposed symmetrically.

3. The massager with a swing structure as claimed in claim 1, wherein the telescopic device is a telescopic motor or a telescopic cylinder.

4. The massager with a swing structure as claimed in claim 1, wherein the telescopic device comprises:
a rotating motor, which is connected with a rotating seat, the rotating seat is cylindrical, a closed-loop guide groove is disposed in the outer peripheral wall of the rotating seat, and the highest point and the lowest point of the guide groove are not on the same horizontal plane;
a guide seat, which is disposed on the outer peripheral wall of the rotating seat, a vertical groove is disposed on the guide seat, and the vertical groove is disposed along the height direction of the guide seat;
a sliding seat, which is provided with a second inner cavity, an opening is formed at the lower end of the second inner cavity, the guide seat extends into the second inner cavity, the sliding seat may slide vertically along the guide seat,
a ball is disposed on the inner wall of the sliding seat, the ball is clamped in the guide groove after passing through the vertical groove, and when the rotating seat rotates, the sliding seat is driven to vertically move in a reciprocating mode through the ball.

5. The massager with a swing structure as claimed in claim 4, wherein a gear box is disposed between the rotating motor and the rotating seat.

6. The massager with a swing structure as claimed in claim 4, wherein the guide groove is composed of two arc-shaped grooves disposed symmetrically.

7. The massager with a swing structure as claimed in claim 4, wherein a first half groove is disposed in the sliding seat, part of the ball is clamped in the first half groove, and the part, extending out of the first half groove, of the ball is clamped in the guide groove.

8. The massager with a swing structure as claimed in claim 7, wherein the sliding seat is provided with a convex part, the convex part extends into the vertical groove, and the convex part may vertically slide along the vertical groove.

9. The massager with a swing structure as claimed in claim 8, wherein the convex part is provided with a second half groove, and the second half groove is provided with a detachable cover body.

10. The massager with a swing structure as claimed in claim 4, wherein a first pivoting part is disposed at the top end of the sliding seat, and the lower end of the connecting rod is in pivot connection with the first pivoting part.

11. The massager with a swing structure as claimed in claim 4, wherein a second pivoting part is disposed in the middle of the swing tongue, a driving arm extends from the rear end of the swing tongue, a third pivoting part is disposed at the position, away from the second pivoting part, of the driving arm, and the third pivoting part is in pivot connection with the upper end of the connecting rod.

12. The massager with a swing structure as claimed in claim 1, wherein the front end of the swing tongue is arc-shaped, and the swing tongue is gradually reduced backwards from the front end.

13. The massager with a swing structure as claimed in claim 4, wherein a position sensor is disposed between the lower end of the sliding seat and the lower end of the guide seat.

14. The massager with a swing structure as claimed in claim 1, wherein the main body comprises a hard shell and a soft shell, the soft shell covers the hard shell, the soft shell is provided with a covering part adaptive to the swing tongue, and the covering part and the soft shell are integrally formed by injection molding.

15. The massager with a swing structure as claimed in claim 14, wherein the hard shell is provided with a groove position, a pivoting hole is disposed at the groove position, the middle of the swing tongue is pivotally mounted to the pivoting hole, and the front part of the swing tongue may extend into the groove position.

16. The massager with a swing structure as claimed in claim 15, wherein a front end shell is disposed at the front end of the hard shell, and a first vibration motor is disposed in the front end shell.

17. The massager with a swing structure as claimed in claim 15, wherein the soft shell comprises a front soft shell and a rear soft shell, the rear soft shell is disposed at the rear part of the front soft shell, the front soft shell and the rear soft shell completely cover the hard shell, and the covering part is disposed on the front soft shell.

18. The massager with a swing structure as claimed in claim 17, wherein a support arm integrally extends from the rear part of the front soft shell, and a second vibration motor is disposed in the support arm.

19. The massager with a swing structure as claimed in claim 11, wherein two symmetric swing tongues are disposed at the upper end of the connecting rod, driving arms of the two swing tongues are disposed in a staggered mode, and the two driving arms are pivotally mounted on the same third pivoting part.

20. The massager with a swing structure as claimed in claim 11, wherein the swing tongue is disposed obliquely or vertically from the upper end of the driving arm.
